(19) United States
(12) Patent Application Publication
(10) Pub. No.: US 2004/0213879 A1
(43) Pub. Date: Oct. 28, 2004

(54) Method for controlling the pressure of a vacuumizer for containers storing food under vacuum

(76) Inventor: Sung Moon Jang, Anyang-si (KR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/486,869

(22) PCT Filed: Aug. 2, 2002
(86) PCT No.: PCT/KR02/01468

(30) Foreign Application Priority Data
Aug. 14, 2001 (KR) 2001/48943

(51) Int. Cl. A23B 4/00

(52) U.S. Cl. 426/404

(57) ABSTRACT

The present invention relates to a pressure control method suitable for devices such as a vacuumizer for use with containers for storing food under vacuum. The inventive method comprises a step of determining a first referential pressure and a second referential pressure, wherein the first referential pressure has a level between a preset vacuum pressure and an atmospheric pressure and the second referential pressure has a level between the present vacuum pressure and the first referential pressure, a step of determining a target pressure of the vacuum chamber from information inputted by the user, a step of operating the evacuation means for the reduction of the pressure, a step of measuring duration time that it takes for the pressure within the vacuum chamber to reach the second referential pressure from the first referential pressure, a step of determining additionally required time that it takes for the pressure within the vacuum chamber to reach the target pressure from the second referential pressure based on the duration time, and a step of further operating the evacuation means for the additionally required time and then stopping the operation of the evacuation means.

### TECHNICAL FIELD

The present invention relates to a pressure control method and, more particularly, to a pressure control method suitable for devices such as vacuumizers for use with containers storing food under vacuum.

### BACKGROUND ART

A vacuumizer for use with containers storing food under vacuum as described above, is disclosed in Korean Patent Application No. 10-2001-0029590. This vacuumizer comprises an opening, a door mounted adjacent to the opening to open and close the same, a vacuum chamber accommodating therein a container in which foodstuffs are kept under vacuum, and an evacuation means connected to the vacuum chamber for evacuating the same. In the vacuumizer configured in this manner, when the user inputs information about conditions in which the foodstuffs are to be stored, a target pressure value is determined and then the evacuation is effectuated.

In a pressure control process where the pressure within the vacuum chamber is changed to the target pressure value that has been previously determined by the information related to the food storage conditions, digital pressure detection sensors have been conventionally used, which emit signals when the pressure within the pressure chamber reaches the target pressure value. However, digital pressure detection sensors are a very expensive component and become a major cause of increase in manufacturing costs of the vacuumizer.

One suggestion for reducing the manufacturing costs of the vacuumizer is not to use the digital pressure detection sensor and to perform the pressure control process in such a way that the pressure in the vacuum chamber reaches the preset target pressure value with only adjusting the operation time of a vacuum pump, as is normally used as an evacuation means in consideration of the capacity of the vacuum pump and volume of the vacuum chamber. However, the pressure control process of this suggestion has a problem that different levels of pressure are generated within the vacuum chamber depending on the volume of the foodstuffs stored therein, although the vacuum pump is operated for same period of time.

### DISCLOSURE OF THE INVENTION

It is an object of the present invention to provide a method for controlling the pressure within a vacuumizer for use with container storing food therein under vacuum to allow the pressure to reach a target pressure value set by information related to food storage conditions.

One aspect of the present invention is a method for controlling pressure within a vacuumizer for use with containers storing food under vacuum. The vacuumizer is provided with an opening, a door mounted adjacent to the opening to close/open the opening, a vacuum chamber accommodating therein the container in which foodstuffs are kept under vacuum, and an evacuation means connected to the vacuum chamber for evacuating the vacuum chamber. The method comprises the steps of, (a) determining a first referential pressure and a second referential pressure, the first referential pressure having a level between a preset vacuum pressure and an atmospheric pressure and the second referential pressure having a level between the preset vacuum pressure and the first referential pressure; (b) determining a target pressure of the vacuum chamber from information related to food storage conditions and input by the user; (c) operating the evacuation means; (d) measuring duration time for the pressure within the vacuum chamber to reach the second referential pressure from the first referential pressure; (e) based on the duration time, determining additionally required time for the pressure within the vacuum chamber to reach the target pressure from the second referential pressure; and (f) further operating the evacuation means for the additionally required time and then stopping the operation of the evacuation means.

Another aspect of the present invention is a method for controlling pressure within a vacuumizer for use with containers storing food under vacuum, where the vacuumizer is provided with an opening, a door mounted adjacent to the opening to close/open the opening, a vacuum chamber accommodating therein the container in which foodstuffs are kept under vacuum, and an evacuation means connected to the vacuum chamber for evacuating the vacuum chamber. The method comprises the steps of, (a) determining a referential pressure having a level between a preset vacuum pressure and an atmospheric pressure; (b) determining a target pressure of the vacuum chamber from information related to food storage conditions and input by the user; (c) operating the evacuation means; (d) measuring duration for the pressure within the vacuum chamber to reach the referential pressure from the atmospheric pressure; (e) based on the duration, determining additionally required time that it takes for the pressure within the vacuum chamber to reach the target pressure from the referential pressure; and (f) further operating the evacuation means for the additionally required time and then stopping the operation of the evacuation means.

In the description, the term “vacuum” does not mean an absolute vacuum state and means a certain level of pressure lower than the atmospheric pressure.

### BRIEF DESCRIPTION OF THE DRAWINGS

FIG. 1a is a front elevational view of one example of a vacuumizer to which the inventive method is applied, and FIG. 1b is a side view of the vacuumizer shown in FIG. 1a.

FIG. 2 shows one example of control panels of the vacuumizer.

FIG. 3 is a flow chart in accordance with a first embodiment of the present invention.

FIG. 4 is an information table presenting information required to determine additional time that it takes for the pressure within the vacuum chamber to reach target pressure, where the information is a function of the target pressure and time interval.

FIG. 5 is a flow chart in accordance with a second embodiment of the present invention.

### MODES FOR CARRYING OUT THE INVENTION

A preferred embodiment of the present invention will now be described in detail with reference to the accompanying drawings.

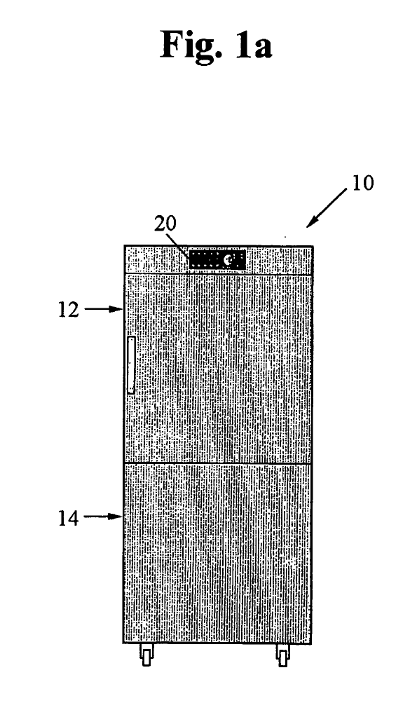

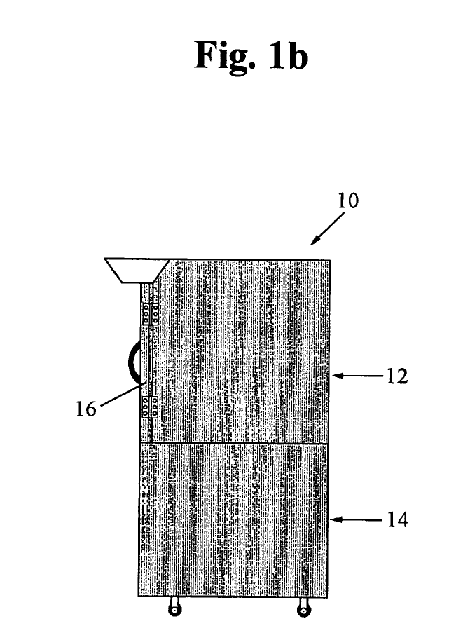

FIG. 1a is a front view of an exemplary vacuumizer for use with a storage container storing food therein under vacuum to which the inventive method is applied, and FIG. 1b is a side view of the vacuumizer 10 shown in FIG. 1a. The vacuumizer 10 comprises a main body 12 having a vacuum chamber therein and a machinery room 14. A vacuum pump or the like is mounted in the machinery room 14.

A vacuum applying line connecting the vacuum chamber to the vacuum pump and a vacuum release line connecting the vacuum chamber to atmosphere extend from the vacuum chamber in the main body 12 to the machinery room 14. A Peltier element, which uses the Peltier effect, may be provided in the vacuum applying line to remove humidity introduced into the vacuum pump. The Peltier element is operated together with the vacuum pump. A sealing configuration is provided between an opening of the vacuum chamber and a door.

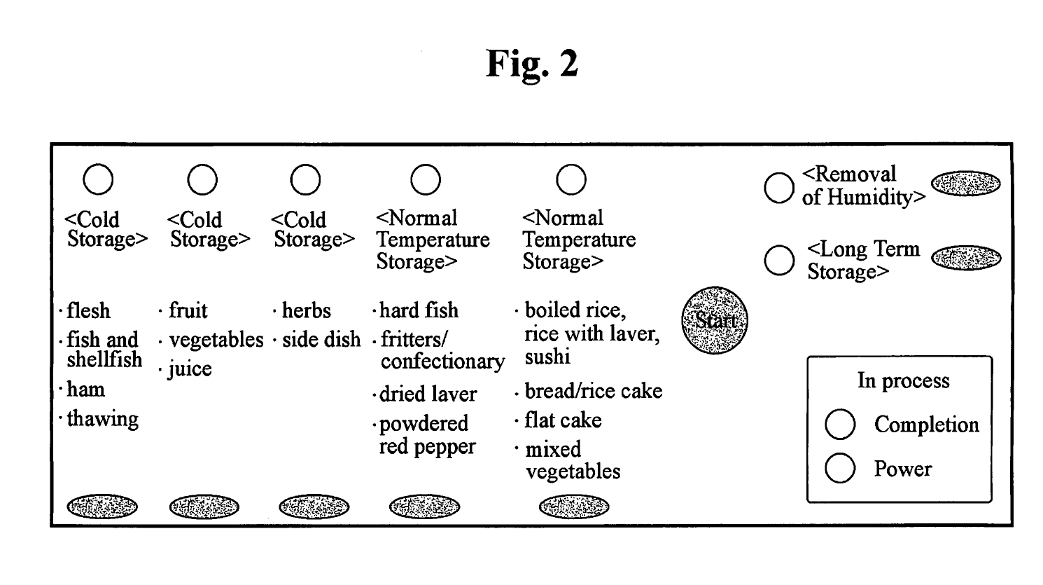

A control panel is provided on a front of the vacuumizer 10. An exemplary control panel 20 shown in FIG. 2 which has a plurality of selection switches for selecting the food storage condition such as a switch for selecting storage temperature, a switch for selecting storage duration, a switch for turning on the dehumidifying function. A power switch, a display window informing on-off status, and a display window informing an operative condition or the like may be further provided on the control panel 20. The switches or windows described above are just examples, the control panel 20 may be configured to have other switches or display windows through which other information related to the food storage condition other than the temperature, the duration and the dehumidifying function can be inputted.

A storage container (not shown) that stores foodstuffs and is used in the vacuumizer 10 is provided with a one-way discharging means such as a check valve, so that when the pressure outside the storage container is lower than the pressure within the storage container, the gas within the storage container can be discharged toward the outside of the storage container. In all other situations, gas flow between the inside and the outside of the storage container is shut off.

A method for controlling the pressure within the vacuum chamber to achieve a desired level of pressure within the vacuum chamber of the vacuumizer 10 configured in this manner will now be described.

First, a target pressure value is determined based on the information related to the food storage condition that is inputted by the user through the control panel 20. In accordance with the present invention, an analog pressure sensor and a timer are used for pressure control to allow the pressure within the vacuum chamber to reach the target pressure value. The analog pressure sensor is responsive to the time when a preset level of pressure is formed within the vacuum chamber.

In a first embodiment of the present invention, a two-contact analog pressure sensor is used. The two-contact analog pressure sensor has a first contact and a second contact. Each of the contacts is exposed to the inside of the vacuum chamber and adapted to respond to different levels of pressure. Therefore, the two-contact analog pressure sensor emits signals when the pressure within the vacuum chamber becomes a particular level of pressure, i.e., a first referential pressure or a second referential pressure. The first referential pressure is determined to have a value between preset vacuum pressure and atmospheric pressure. The level of pressure becomes lower in this order of the atmospheric pressure, the first referential pressure, the second referential pressure, the preset vacuum pressure.

In a second embodiment of the present invention, a one-contact analog pressure sensor is employed. The contact of the one-contact pressure sensor is responsive to a referential pressure having a level between the preset vacuum pressure and the atmospheric pressure, so that the one-contact pressure sensor emits signals when the pressure within the vacuum chamber becomes the referential pressure.

In the description, the term “the preset vacuum pressure” means a certain level of pressure sufficiently higher than the target pressure value determined depending upon the input information related to the food storage condition. The level of the preset vacuum pressure may be determined by taking the accuracy of the pressure sensor and the capacity of the vacuumizer into consideration.

The first embodiment of the present invention is now described with reference to drawings.

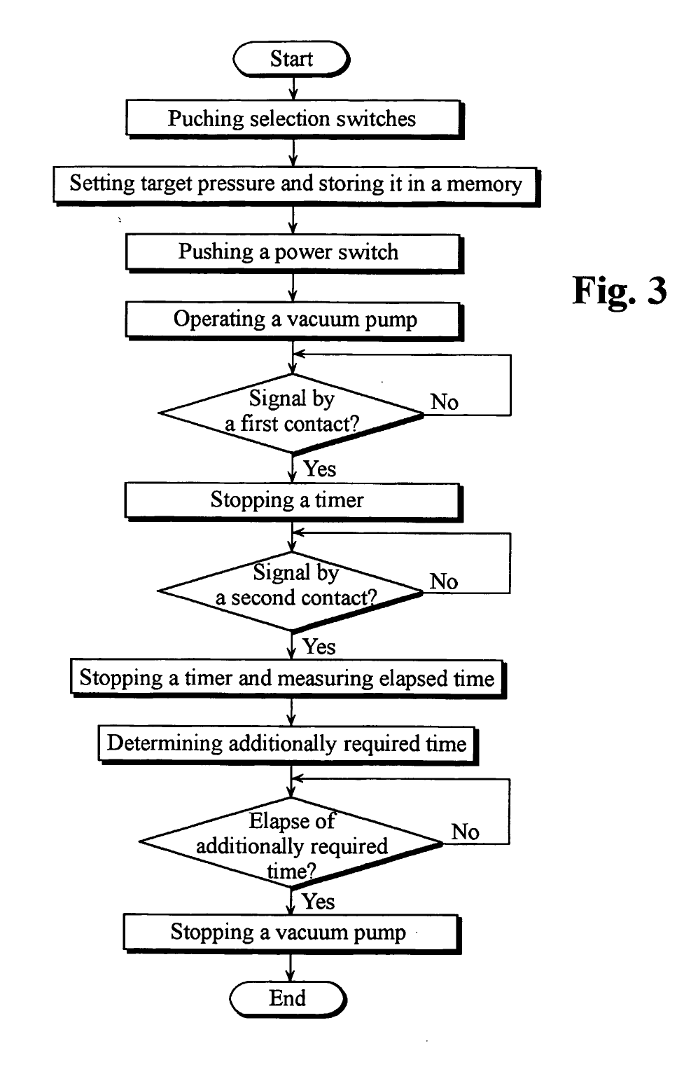

Referring to FIG. 3, when the user inputs the information related to the food storage condition through the selection switch 21a in step 22, the value of the target pressure under which the foodstuffs will be stored is determined and stored in a memory in step 24. As shown in FIG. 2, in the first embodiment, the input process of the information related to the food storage condition is completed only by selecting the storage temperature, the storage duration and the use of the dehumidification function. Next, a power switch 21b is switched on in step 26, the vacuum pump starts to operate in step 28.

When the pressure within the vacuum chamber begins to drop to reach the first referential pressure through the operation of the vacuum pump in step 30, a signal is emitted from the two-contact pressure sensor due to the detection by the first contact to trigger the operation of the timer in step 32. The continued operation of the vacuum pump further drops the pressure within the vacuum chamber. When the pressure within the vacuum chamber reaches the second referential pressure, a signal is emitted from the two-contact pressure sensor due to the detection by the second contact in step 34. In the next step 36, the operation of the timer is stopped by the signal emitted by the detection by the second contact and then the duration time that it takes for the pressure within the vacuum chamber to get to the second referential pressure from the first referential pressure is calculated.

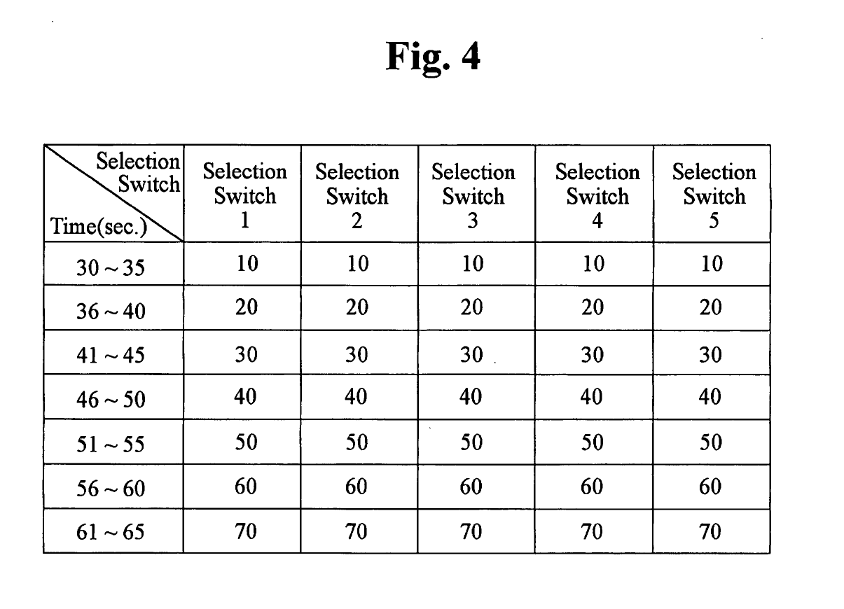

Next, additionally required time that it will take for the pressure within the vacuum chamber to get to the target pressure from the second referential pressure is determined based on the duration time that it takes for the pressure within the vacuum chamber to get to the second referential pressure from the first referential pressure, i.e., the time period measured by the timer (step 38). FIG. 4 is a table presenting information required to determine the additionally required time that it takes for the pressure within the vacuum chamber to reach the target pressure, where the information is obtained by using a function of the target pressure and the duration time and may be used in the form of data stored, e.g., in the memory of a computer system. This information table is just exemplary and the additionally required time may be determined by a formula having the target pressure and the duration time as variables or through experiments.

For example, the information table for determining the additionally required time may be completed by the following formula:

Additionally required time=Coefficient×{Duration time/(First referential pressure−Second referential pressure)}×(Second referential pressure−Target pressure)

wherein the coefficient is a constant that can be determined through experiments or the like.

For example, when a selection switch 2 is selected, the corresponding target pressure is determined. If the duration time that it takes for the vacuum chamber to reach the second referential pressure from the first referential pressure is 37 seconds, the additionally required time is 20 seconds in accordance with the information table shown in FIG. 4. The larger the volume of the foodstuffs, the smaller the duration time. In other words, the reduced space to be evacuated (i.e., the volume of the vacuum chamber−the volume of the foodstuffs) reaches the target pressure in reduced duration time.

According to the principle described above, after the pressure within the vacuum chamber reaches the second referential pressure, the vacuum pump is further operated for the additionally required time and then stopped (steps 40 and 42).

Although one two-contact pressure sensor is used to detect the time when the pressure within the vacuum chamber reaches the first referential pressure or the second referential pressure in this embodiment, two one-contact pressure sensors responsive to the first referential pressure or the second referential pressure, respectively, may be used.

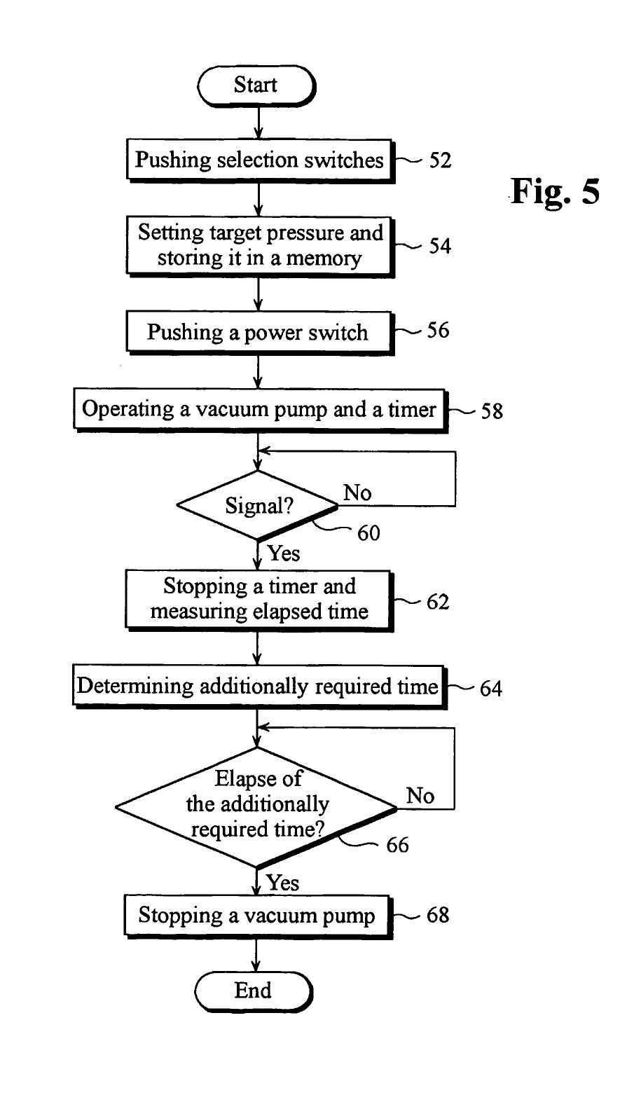

The second embodiment of the present invention is now described with reference to FIG. 5. Like the first embodiment, when the user inputs the information related to the food storage condition by using the selection switch 21a, the target pressure with the food to be stored under vacuum is set and stored in the memory (steps 52 and 54). In this embodiment, selection of the storage temperature, the storage duration and the use of the dehumidification function completes the input process of the information related to the food storage condition. Next, a power switch 21b is switched on in step 56, and the vacuum pump starts to operate in step 58.

In this embodiment, the operation of the vacuum pump is concurrently started with the operation of the timer. When the pressure within the vacuum chamber begins to drop to reach the referential pressure through the operation of the vacuum pump, a signal is emitted from the one-contact pressure sensor due to the detection by the contact (step 60). The signal stops the operation of the timer and then duration time that it takes for the pressure within the vacuum chamber to get to the referential pressure from the atmospheric pressure is calculated (step 62).

Next, an additionally required time that it will take for the pressure within the vacuum chamber to get to the target pressure from the referential pressure is determined by using a function of the duration time and the target pressure set by the information related to the food storage condition. The additionally required time may be determined in the same manner as in the first embodiment (step 64).

After the pressure within the vacuum chamber reaches the referential pressure, the vacuum pump is further operated for the additionally required time and then stopped (steps 66 and 68).

Alternatively, although the sealing configuration is provided between the opening of the vacuum chamber and the door, outside air may be introduced into the vacuum chamber at an initial operation of the vacuum pump. The introduction of the outside air into the vacuum chamber may result in a non-linear characteristic in a relation between the target pressure and the duration time that it takes for the pressure within the vacuum chamber to reach the referential pressure from the atmospheric pressure. However, this non-linear characteristic relation may be ignored in determining the additionally required time that it will take for the pressure within the vacuum chamber to reach the target pressure.

Therefore, the method of the first embodiment is appropriate when a very exact pressure control is required. The method of the second embodiment has an advantage in that it provides both a reduction of the manufacturing cost of the vacuumizer and more simplified pressure control process since it employs only one pressure sensor having a contact.

### INDUSTRIAL APPLICABILITY

In accordance with the present invention, the pressure within the vacuum chamber may be exactly controlled to reach the target pressure determined depending upon the information related to the food storage condition and input by the user without using expensive digital pressure detection sensors. Accordingly, the manufacturing cost of the vacuumizer can be reduced.

1. A method for controlling pressure within a vacuumizer for use with containers storing food under vacuum, the vacuumizer provided with an opening, a door mounted adjacent to the opening to close/open the opening, a vacuum chamber accommodating therein the container in which foodstuffs are kept under vacuum, and an evacuation means connected to the vacuum chamber for evacuating the vacuum chamber, the method comprising the steps of:
a) determining a first referential pressure and a second referential pressure, the first referential pressure having a level between a preset vacuum pressure and an atmospheric pressure and the second referential pressure having a level between the preset vacuum pressure and the first referential pressure;
b) determining a target pressure of the vacuum chamber from information related to food storage conditions and input by the user;
c) operating the evacuation means;
d) measuring duration time that it takes for the pressure within the vacuum chamber to reach the second referential pressure from the first referential pressure;
e) based on the duration time, determining additionally required time that it takes for the pressure within the vacuum chamber to reach the target pressure from the second referential pressure; and
f) further operating the evacuation means for the additionally required time and then stopping the operation of the evacuation means.

2. A method for controlling pressure within a vacuumizer for use with containers storing food under vacuum, the vacuumizer provided with an opening, a door mounted adjacent to the opening to close/open the opening, a vacuum chamber accommodating therein the container in which foodstuffs are kept under vacuum, and an evacuation means connected to the vacuum chamber for evacuating the vacuum chamber, the method comprising the steps of
a) determining a referential pressure having a level between a preset vacuum pressure and an atmospheric pressure;
b) determining a target pressure of the vacuum chamber from information related to food storage conditions and input by the user;
c) operating the evacuation means;
d) measuring duration time that it takes for the pressure within the vacuum chamber to reach the referential pressure from the atmospheric pressure;
e) based on the duration time, determining additionally required time that it takes for the pressure within the vacuum chamber to reach the target pressure from the referential pressure; and
f) further operating the evacuation means for the additionally required time and then stopping the operation of the evacuation means.

3. The method of claim 1, wherein an analog pressure sensor having at least one contact is employed in step (d).

4. The method of claim 1, wherein, in step (e), the additionally required time is determined by using a function of the target pressure and the duration time measured in step (d).
